(19) United States
(12) Patent Application Publication
(10) Pub. No.: US 2010/0018205 A1
(43) Pub. Date: Jan. 28, 2010

(54) SOLAR POWER GENERATOR

(76) Inventor: Shih H. Chen, Yongkang City (TW)

Correspondence Address: HDLS Patent & Trademark Services, P.O. BOX 220746, CHANTILLY, VA, 20153-0746, US

(21) Appl. No.: 12/419,412

(22) Filed: Apr. 7, 2009

(30) Foreign Application Priority Data
Jul. 25, 2008 (TW) 097213312

(51) Int. Cl. F03G 6/00

(52) U.S. Cl. 60/641.8

(57) ABSTRACT

A solar power generator includes a support, a base, a light-transmitting plate and a generator set. The base is connected to the support. The bottom of the base is provided with a plurality of air holes. The light-transmitting plate is connected to the base to form an accommodating space. The light-transmitting plate is provided with an air outlet in communication with the accommodating space. The generator set is provided in the air outlet and has an impeller and a generator connected to the impeller. When gas enters from the air holes and flows outside via the air outlet, the gas drives the impeller to rotate and then the rotation energy is converted into outputted electricity via the generator. Via this arrangement, the amount of heat exchange between internal gases and external gases and the flowing speed of gas can be increased, so that the generation performance of the generator can be improved.

### BACKGROUND OF THE INVENTION

1. Field of the Invention

The present invention relates to a generator, and in particular to a solar power generator.

2. Description of Prior Art

Since petroleum and other natural resources have been exploited and used greatly, their quantity reduces gradually, so that their price has been raised continuously. On the other hand, the gas exhausted after the burning of petroleum (such as CO₂) becomes one of the primary factors in the ozone depletion and greenhouse effect. According to the above reasons, many kinds of substitute energies such as wind power, solar power or water power have become an important topic for research in the industry. Among these popular substitute energies, solar power generation has been widely used. The solar power generation includes two categories: solar photo-voltaic generation and solar thermal generation. However, most of the existing solar power generators are poor in their generation efficiency. Therefore, it is an important issue to improve the solar power generator.

One of the solar power generators in prior art utilizes the concept of a solar chimney. Please refer to FIG. 1. Such a solar power generator includes a plurality of longitudinal rods 11a, a light-transmitting plate 30a, a generator set 40a and an upright pipe 50a. The longitudinal rods 11a are fixed on the ground 6a at an interval. The top of the longitudinal rod is connected to the light-transmitting plate 30a. The center of the light-transmitting plate 30a is provided with an air outlet 31a. The air outlet 31a is connected with the upright pipe 50a. The generator set 40a is received in the upright pipe 50a. In this way, a solar chimney generator can be obtained.

However, in practice, the conventional solar chimney generator still has problems as follows. The primary heat-absorbing body in the generator is the ground. After being irradiated by the sunshine, the temperature of the ground rises to heat up the gas on the ground. Such a horizontal heat exchange can only generate small amount of heat exchange in gas and result in a low flowing speed of gas. Since the generation efficiency of the generator set 40a depends on the airflow speed or flow rate of the impeller mounted thereon, low flowing speed of gas will result in poor generation efficiency of the generator set 40a. Since the effect of increasing temperature inside the generator is not clear and laterally-arranged air inlets make the internal gases to partially flow outside via the intervals of respective longitudinal rods 11a easily, the amount of gas flowing outside via the air outlet 31a is thus reduced, which in turn decreases the productivity of the generator set 40a. Therefore, there is still room for improvement.

### SUMMARY OF THE INVENTION

The present invention is to provide a solar power generator. An accommodating space formed between a base and a light-transmitting plate is used to increase the temperature greatly, thereby increasing the amount of heat exchange between internal gases and external gases and the flowing speed of gas. Thus, the generation efficiency of the generator can be improved.

The present invention is to provide a solar power generator, which includes a support, a base, a light-transmitting plate and a generator set. The base is connected to the support. The bottom of the base is provided with a plurality of air holes. The light-transmitting plate is air-tightly connected on the base to form an accommodating space. The light-transmitting plate is provided with an air outlet in communication with the accommodating space. The generator set is assembled in the air outlet. The generator set comprises an impeller and a generator connected to the impeller. When gas enters the generator via the air holes and flows outside via the air outlet, the gas will drive the impeller to rotate. The rotation energy of the impeller is converted into outputted electricity via the generator.

The present invention is to provide a solar power generator. With an elevated base and the air holes arranged below the base, the high-temperature gas and the low-temperature gas are not interfered with each other. Further, the pressure accumulated in the base will not be dissipated easily via the lateral surface, so that the flowing speed of gas entering or exiting the accommodating space can be increased.

### BRIEF DESCRIPTION OF THE DRAWINGS

FIG. 1 is an assembled view showing a generator according to prior art;

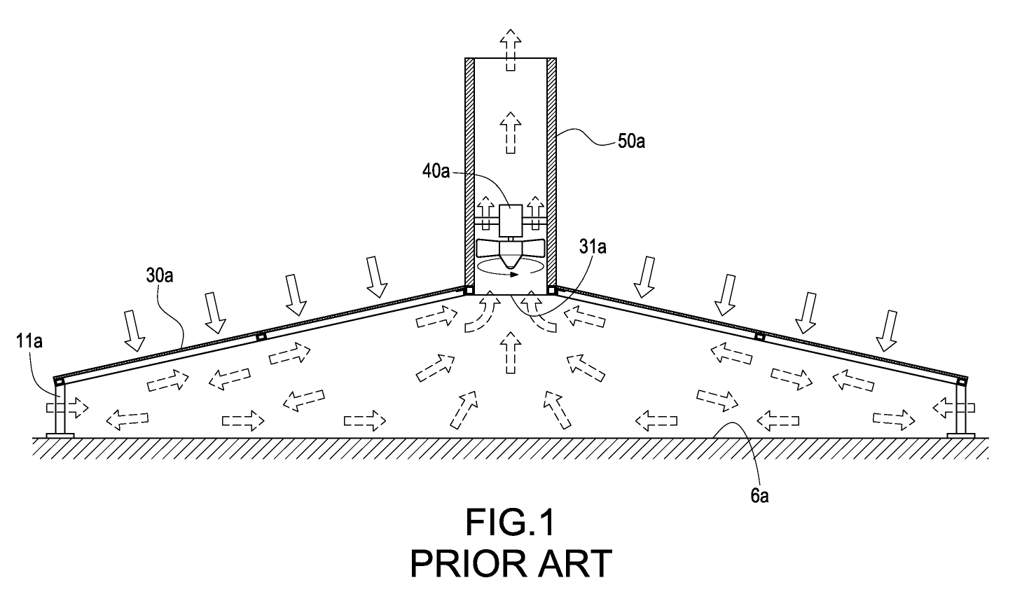

FIG. 2 is an assembled view showing a generator according to the present invention;

FIG. 3 is a partially enlarged view showing the region A in FIG. 2;

FIG. 4 is an assembled view showing another embodiment of the present invention;

FIG. 5 is a schematic view showing the operating state of another embodiment of the present invention;

FIG. 6 is an assembled view showing a further embodiment of the present invention; and

FIG. 7 is a partially enlarged view showing the region B in FIG. 6.

### DETAILED DESCRIPTION OF THE INVENTION

The characteristics and technical contents of the present invention will be explained with reference to the accompanying drawings. However, the drawings are illustrative only but not used to limit the present invention.

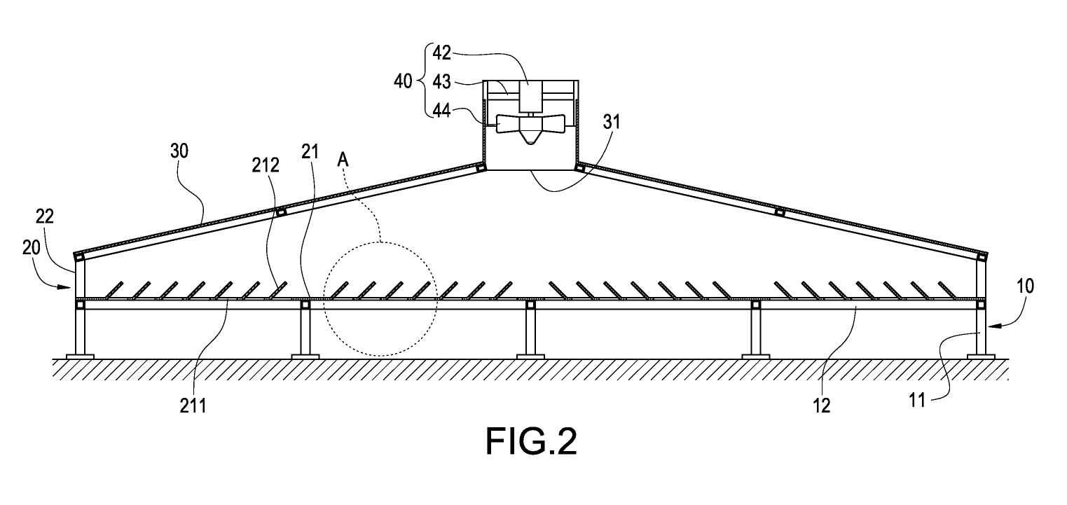

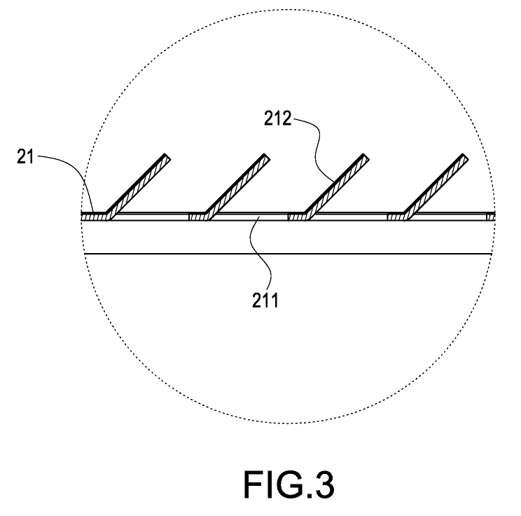

Please refer to FIGS. 2 and 3. FIG. 2 is an assembled view showing a generator according to the present invention, and FIG. 3 is a partially enlarged view showing the region A in FIG. 2. The present invention provides a solar power generator, which includes a support 10, a base 20, a light-transmitting plate 30 and a generator set 40.

The support 10 is constituted of a plurality of longitudinal rods 11 and a plurality of transverse rods 12 connected to the longitudinal rods 11 respectively. The support 10 is used to elevate the base 20 from the ground to a suitable height.

The base 20 is constituted of a bottom plate 21 and a plurality of surrounding plates 22 bent and extending upwards from the periphery of the bottom plate 21. The bottom plate 21 is made of materials having good heat absorbency. Alternatively, coating with high heat absorbency is applied on the upper surface of the bottom plate 21 directly (not shown). The bottom plate 21 is connected to the transverse rods 12 of the support 10. The bottom plate 21 is provided with a plurality of air holes 211. In the present embodiment, the bottom plate 21 is provided with the air holes 211 via a stamping process and the bottom plate 21 is bent to form an inclined piece 212 so as to increase the total surface area of the bottom plate 21 for absorbing heat. There may be a plurality of inclined pieces 212 that are made of materials with good heat absorbency. After being manufactured completely, the inclined pieces 212 are connected with the bottom plate 21 to form air holes 211. The angle between the inclined piece 212 and the bottom plate 21 can be adjusted according to the practical demands, thereby increasing the area for absorbing the solar radiation efficiently. With this arrangement, the bottom plate 21 can have a good heat-exchanging performance with the air.

The light-transmitting plate 30 is made of glass or acrylic materials having good light transmittance. The light-transmitting plate 30 is air-tightly connected to the respective surrounding plates 22 of the base 20, thereby forming an accommodating space. Further, the center of the light-transmitting plate 30 extends to form an air outlet 31 that is in communication with the accommodating space.

The generator set 40 is mounted to correspond to the air outlet 31. The generator set 40 comprises an impeller 41, a generator 42 connected to the impeller 41 and a supporting rod 43 connected to the generator 42. Via the supporting rod 43, the impeller 41 and the generator 42 can be fixed to the interior of the air outlet 31.

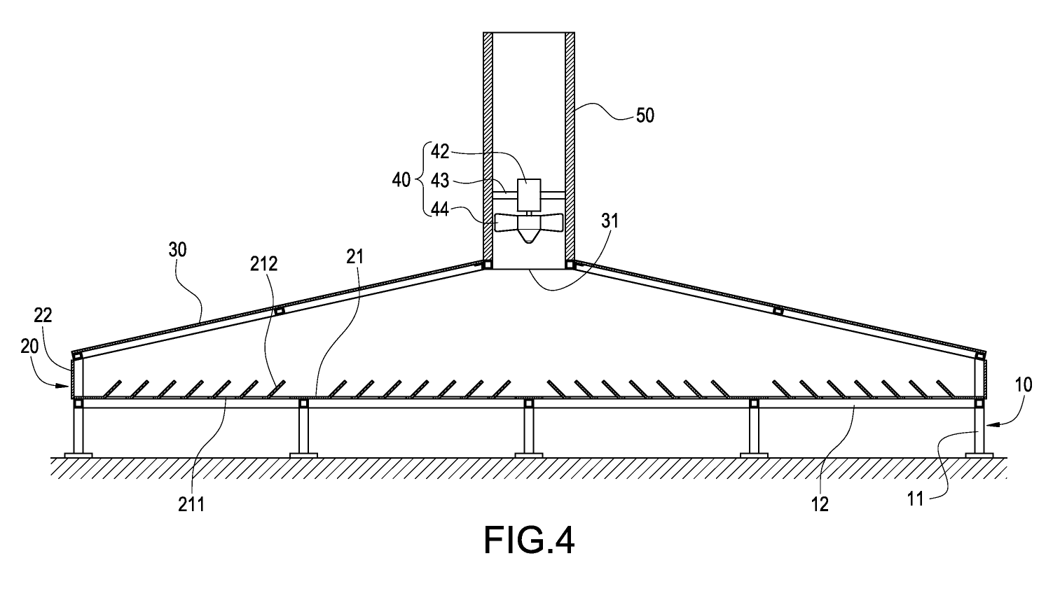

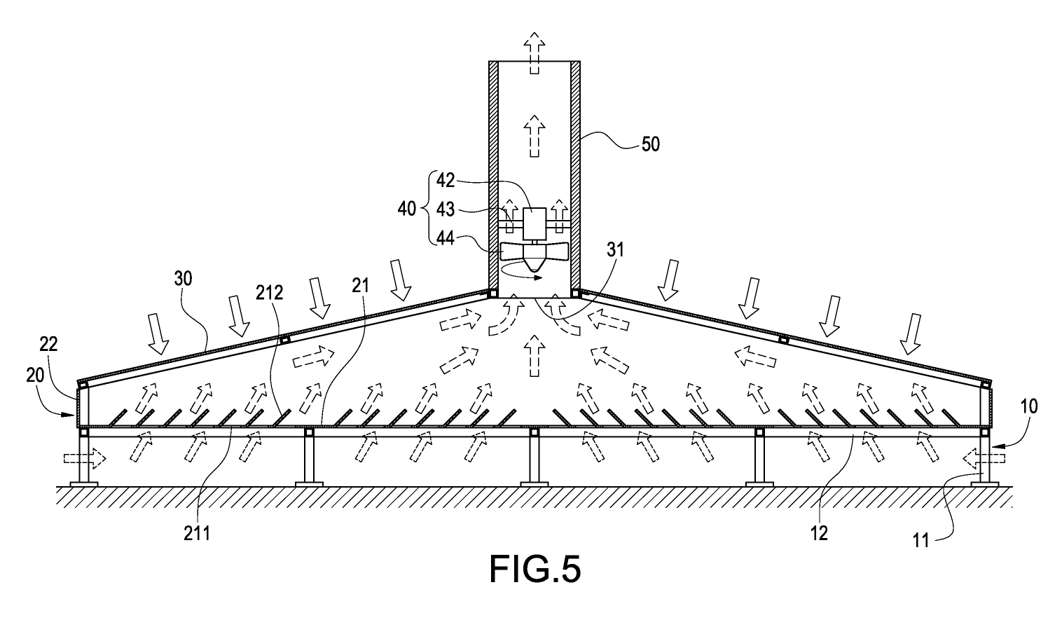

Please refer to FIGS. 4 and 5. FIG. 4 is an assembled view showing another embodiment of the present invention, and FIG. 5 is a schematic view showing the operating state of another embodiment of the present invention. In the present embodiment, the generator further includes an upright pipe 50. The bottom end of the upright pipe 50 is connected to the air outlet 31 of the light-transmitting plate 30. The upright pipe 50 is formed into a longitudinal pipe. The generator set 40 is fixedly connected to the interior of the upright pipe 50. In use, when the solar radiation passes through the light-transmitting plate 30 and irradiates the bottom plate 21 or the inclined pieces 212 to heat up the bottom plate 21 or the inclined pieces 212, the bottom plate 21 and the inclined pieces 212 together form a three-dimensional heat exchanger, thereby transmitting heat to ambient air. Since the increase in the area of the heat exchanger also raises the efficiency of heat exchange, the accommodating space enclosed by the base 20 and the light-transmitting plate 30 generates an effect of increasing temperature. Since hot gas tends to float upwards, the low-temperature gas outside the accommodating space flows into the accommodating space via the respective air holes 211 of the bottom plate 21, so that the gas circulates in the solar power generator continuously to cause the high-temperature gas within the accommodating space to flow toward the air outlet 31 of the light-transmitting plate 30. The reduced cross section of the upright pipe 50 can increase the flowing speed of gas. The gas having high flowing speed may drive the impeller 41 of the generator 40. The kinetic energy generated by the rotation of the impeller 41 can be converted into outputted electricity via the generator 42.

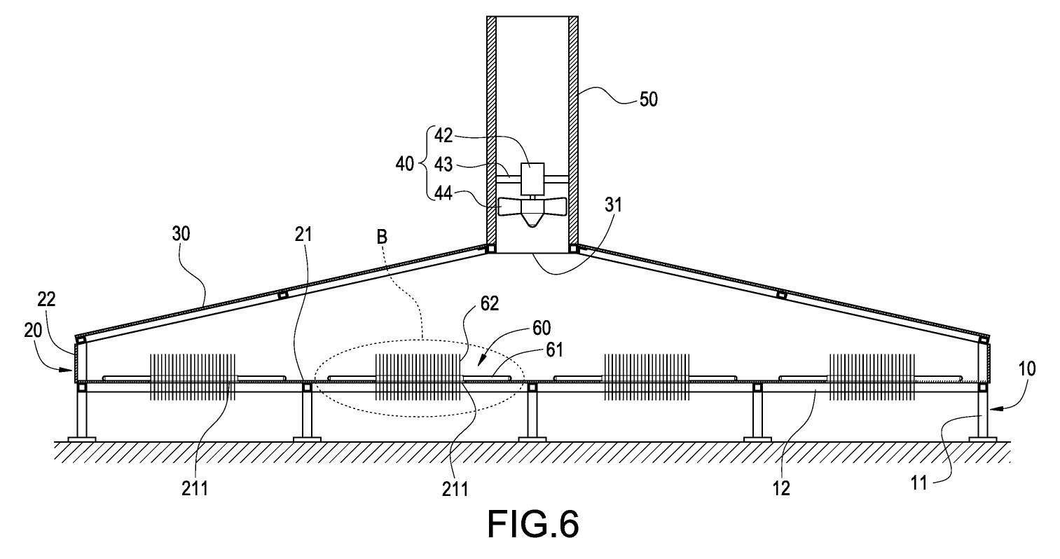

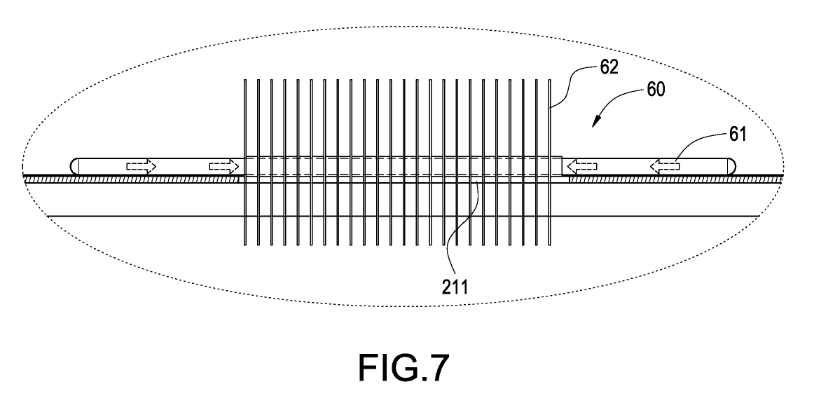

Please refer to FIGS. 6 and 7. FIG. 6 is an assembled view showing a further embodiment of the present invention, and FIG. 7 is a partially enlarged view showing the region B in FIG. 6. In addition to the above embodiments, the generator of the present invention further includes a heat exchanger 60. The heat exchanger 60 includes a phase change heat conductor 61 and a plurality of heat-absorbing pieces 62 connected to the heat conductor 61. The phase change heat conductor 61 may be a heat pipe or a vapor chamber. Both ends of the heat conductor 61 straddle on the bottom plate 21. Each of the heat-absorbing pieces 62 is formed at the air holes 211. With the high heat-conducting effect of the heat conductor 61, a large amount of sunshine can be absorbed to generate a high temperature. The heat in such a high temperature can be conducted rapidly to the respective heat-absorbing pieces 62. Since the heat-absorbing pieces 62 are three-dimensional fins, they have a large area for contacting air. The fins are arranged to be perpendicular to the ground. Thus, such three-dimensional fins generate a heat-exchanging effect superior to a two-dimensional heat-exchanging effect on a horizontal ground. In this way, the thermal convection and the heat-exchanging process can be enlarged, so that the generation performance of the generator of the present invention can be increased greatly.

According to the above, the solar power generator of the present invention already demonstrates industrial applicability, novelty and inventive steps. Further, the construction of the present invention has not been seen in products of the same kind and let in public use. Thus, the present invention conforms to the requirements for a utility model patent.

What is claimed is:

1. A solar power generator, comprising:
a support;
a base connected to the support, the bottom of the base being provided with a plurality of air holes;
a light-transmitting plate air-tightly connected to the base to form an accommodating space, the light-transmitting plate being provided with an air outlet in communication with the accommodating space; and
a generator set provided on the air outlet, the generator set comprising an impeller and a generator connected to the impeller;
when gas enters from the air holes and flows outside via the air outlet, the gas drives the impeller to rotate and then the rotation energy of the impeller is converted into outputted electricity via the generator.

2. The solar power generator according to claim 1, wherein the base comprises a bottom plate and a plurality of surrounding plates connected to the periphery of the bottom plate, the air holes are provided on the bottom plate.

3. The solar power generator according to claim 2, wherein one side of the bottom plate on which the air holes are provided is formed upwards with an inclined piece.

4. The solar power generator according to claim 2, wherein, the bottom plate is made of materials having heat absorbency.

5. The solar power generator according to claim 4, further comprising a heat exchanger connected to the bottom plate.

6. The solar power generator according to claim 5, wherein the heat exchanger comprises a phase change heat conductor and a plurality of heat-absorbing pieces connected to the heat conductor, both ends of the heat conductor straddle on the bottom plate, the heat-absorbing pieces are formed in the air holes.

7. The solar power generator according to claim 6, wherein the phase change heat conductor is a heat pipe.

8. The solar power generator according to claim 6, wherein the phase change heat conductor is a vapor chamber.

9. The solar power generator according to claim 1, further comprising an upright pipe, the upright pipe being connected to the air outlet of the light-transmitting plate, the generator set being received and connected within the upright pipe.

10. The solar power generator according to claim 1, wherein the generator set further comprises a supporting rod, the supporting rod is used to fix the impeller and the generator in the air outlet.
